(19) United States
(12) Patent Application Publication
(10) Pub. No.: US 2025/0271825 A1
(43) Pub. Date: Aug. 28, 2025

(54) APPARATUS FOR ESTIMATING THE VALUE OF A SOLAR POWER PLANT

(71) Applicant: Guang Teng Renewable Energy Co., Ltd., New Taipei City (TW)

(72) Inventors: An-Hsing CHANG, New Taipei City (TW); Ming-Che CHUANG, Taichung City (TW); Shih-Kuei LIN, Taipei City (TW); Che-Yi YIN, Kaohsiung City (TW)

(73) Assignee: Guang Teng Renewable Energy Co., Ltd., New Taipei City (TW)

(21) Appl. No.: 19/182,352

(22) Filed: Apr. 17, 2025

Related U.S. Application Data
(63) Continuation-in-part of application No. 17/896,694, filed on Aug. 26, 2022.

(51) Int. Cl. G05B 19/042

(52) U.S. Cl. CPC G05B 19/042; G05B 2219/2639

(57) ABSTRACT

An apparatus for estimating a fair value of a SPP includes a sunshine simulation system for generating a peak sun hour; a photovoltaic (PV) yield system for measuring a total power loss rate and generating an estimated energy-production-hours database; and a financial pricing system for generating a series of cash flows and discount factors. The financial pricing system computes a series of present values which are the product of the cash flows and the discount factors, and sums up all the present values to obtain an estimated value of the SPP. Since the apparatus for estimating SPP value takes the real power generation condition of the SPP and the real market economic condition into consideration, the apparatus can generate a pricing result even closer to the real market.

### CROSS-REFERENCE TO RELATED APPLICATIONS

This application is a continuation-in part of U.S. patent application Ser. No. 17/896,694, filed Aug. 26, 2022.

### FIELD OF THE INVENTION

The present invention relates to an apparatus for estimating a fair value of an existing solar power plant or a new solar power plant (hereafter SPP), and more particularly, to a pricing apparatus with capabilities of simulating sunshine hours, power loss and financial market risk factors.

### BACKGROUND OF THE INVENTION

Since the high degree of industrialization, for economic development, human society has overused fossil fuels and deforested. It disrupts the carbon cycle on Earth. As a result, greenhouse gases on the Earth's surface largely increase to cause increasingly evident global warming. Climate abnormality constantly appears in different areas of the world.

The 2011 destructive Great Tohoku Earthquake in Japan triggered nuclear leakage in Fukushima nuclear power plant. Since then, global governments started to re-examine their energy-related policy. Now, the whole world is promoting the use of renewable energy and trying to convert the power of nature into the energy needed by human life.

Solar power energy has the advantages of being clean and sustainable, having no geographical restrictions, and so on. It plays a considerably critical role in global green energy development. A SPP can stably provide green power. However, the condition of photovoltaic (hereafter PV) power generation is high concerning the environment and climate of Earth. Further, the power generation capacity of a SPP is significantly influenced by the maintenance and environmental conditions of the SPP.

In the process of promoting green power development, making a profit is still an important factor being considered. SPP owners or investors usually disposed of the SPP while the cost is recovered. At this time, they will subsequently seek the counterparty and sell the SPP. Therefore, how to estimate property the value of the SPP is a very important issue before making the sale.

Valuating investment in renewable energy is extremely complex because it involves very comprehensive knowledge. From the perspective of the accounting field, there are three approaches to value the SPP: the cost approach, the income approach and the market approach.

In the cost approach, the costs of construction and maintenance, and the depreciation fee for the SPP are used to determine the fair value of the SPP. This approach generally works for valuing a new SPP instead of an existing SPP. The reason is that, for the existing SPP, the power generating features and the financial market characteristics are different from the beginning. Therefore, under the cost approach, the existing SPP will be mispriced.

In the income approach, the sum of discounted cash flow is used to determine the fair value of SPP. The SPP can be seen as an asset generating cash flow periodically. Given the discount rate (required rate of return or the weighted average cost of capital) and the series of cash flow, the SPP can be priced. However, the SPP generates power only if the sunshine is sufficient. Thus, the impact of weather factors on periodic electricity generation must be introduced into the pricing model. Under this circumstance, seeing the SPP as a fixed-income asset will result in mispricing.

In the market approach, the fair value of SPP is determined by the price of other SPP transactions with similar power generating features and geographical characteristics. However, because there is no exchange market and quoting over-the-counter for SPP, it is difficult to acquire the transaction prices and available information of other SPPs.

Please refer to FIG. 1. Most of the currently existing SPP value estimating models adopt technical due diligence (hereafter DD), asset DD, and internal rate of return (IRR) analysis. The existing models use both the cost approach and the income approach to identify potential risks and further estimate the remaining value of SPP. That is the average energy production hours of the SPP and a fixed depreciation rate are used to evaluate the performance of the financial investment. Then, comprehensive evaluations are conducted to derive investors' investment amount or purchase price. Finally, the transaction amount is determined by the negotiation between the investor and her/his counterparty.

In most cases, both of the seller and the buyer are not aware of a real value of the SPP. To trade the SPP quickly and successfully to both parties, it is necessary to rely on a value estimating apparatus, which generates a fair value of SPP and is seen as a third party. It is helpful for both parties quickly reach a consensus. It also improves the transaction liquidity in the SPP market.

### SUMMARY OF THE INVENTION

A primary object of the present invention is to provide a value estimating apparatus for establishing a fair-trade mechanism. The value estimating apparatus includes a sunshine simulation system and a PV yield system. The PV yield system can obtain similar outputs between the theoretical and the real results of a SPP. The value estimating apparatus also introduces a plurality of stochastic factors of interest rates and a plurality of exchange rates into the model. Therefore, the results from the value estimating apparatus of the present invention are close to the real market.

Another object of the present invention is to provide a value estimating apparatus that can be applied to estimate values of both existing and new SPPs. That is, the value estimating apparatus according to the present invention can be applied to different types of SPPs.

To achieve the above and other objects, the value estimating apparatus of the present invention is mainly used to estimate the value of a SPP. The SPP can be an existing SPP or a new one. The value estimating apparatus comprises at least one computer configured to implement a sunshine simulation system for simulating peak sun hour (hereafter PSH), a PV yield system for measuring a total power loss rate, and a financial pricing system for estimating the value of the SPP in the real market.

The sunshine simulation system is installed in the at least one computer and includes a sunshine data creation module and a sunshine-hours prediction module. The sunshine data creation module links to a database through the Internet to get historical data including sunshine and temperature from the SPP while creating a SPP database base on the historical data. The sunshine-hours prediction module includes a SPP simulation model. The SPP database is input to the SPP simulation model to generate the PSH.

The PV yield system is installed in the at least one computer and includes a power loss computation module and an energy-production-hours computation module. The power loss computation module links to the SPP through the Internet and receives a module attenuation correction, a module temperature correction, a length of wire correction, a type of inverter correction, and a power conversion correction to generate a total power loss rate. The energy-production-hours computation module generates an estimated energy-production-hours database from the PSH and the total power loss rate.

The financial pricing system is installed in the at least one computer and includes a cash flow module, a financial risk module, and a value pricing module. The cash flow module generates a series of cash flows from the estimated energy-production-hours database multiplying a pre-determined purchase price. The financial risk module links to a financial data server to get financial historical data including a plurality of domestic and foreign Treasury yield curves, a plurality of exchange rates, and a plurality of interest rates; the financial risk module creates a risk simulation model based on the exchange rates and the interest rates; the risk simulation model creates a plurality of parameters from the domestic and foreign Treasury yield curves and the exchange rates. The financial risk model generates a series of discount factors with a plurality of simulated interest rates and a plurality of simulated exchange rates. The value pricing module computes a series of present values of the cash flows; the present values are the product of the cash flows and the discount factors. Then the value pricing module sums up all the present values to obtain an estimated value of the SPP. The apparatus supplies the estimated value of the SPP to a party in a trade involving the SPP.

The SPP simulation model is created according to either data of an existing SPP or data of a new SPP. The data of the existing SPP includes historical data including sunshine hours and temperature from the SPP; the data of the new SPP includes historical data including sunshine hours and temperature from a weather bureau.

In the case of the existing SPP, the PV yield system further includes a module data creation module for getting module temperature data, power generation data and wind speed data.

The sunshine data creation module organizes different SPP data in a unified format. And, the SPP simulation model further introduces a seasonal mean and a seasonal variance of climate factors into an algorithm.

In a preferred embodiment, the power loss computation module further gets an installation orientation and tilt angle correction coefficient and a wind speed correction coefficient to help computation of the total power loss rate. In another preferred embodiment, the power loss computation module further gets an auxiliary parameter loss rate to help computation of the total power loss rate; and the auxiliary parameter correction includes a fault loss coefficient, a hot spot loss coefficient, and a connector and socket loss coefficient.

The present invention emphasizes the establishment of a fair-trade mechanism of SPP to greatly improve a misestimated price due to asymmetric information. The invention is helpful for both parties quickly reach a consensus, and also improves the transaction liquidity in the SPP market.

### BRIEF DESCRIPTION OF THE DRAWINGS

To achieve the above and other objects, the structure and the technical means adopted by the present invention can be best understood by referring to the following detailed description of the preferred embodiment and the accompanying drawings, wherein

FIG. 1 is a conceptual view of a conventional SPP value estimating mode;

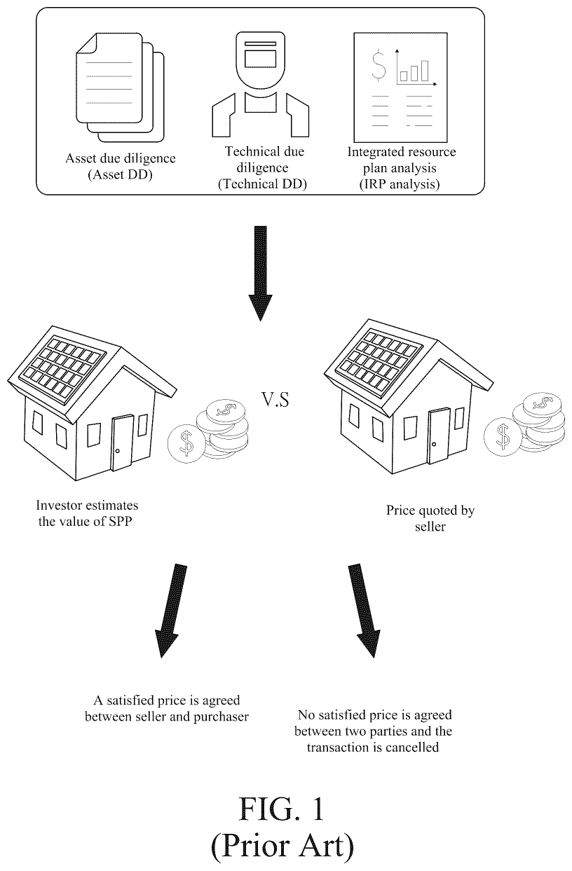

FIG. 2 is a conceptual view of a new mode of SPP value estimating according to the present invention;

FIG. 3 is a flowchart showing the steps included in the value estimating mode of the present invention;

FIG. 4 is a block diagram of the value estimating apparatus of the present invention;

FIG. 5 is a conceptual view showing the conversion of sunshine hours into PSH;

FIG. 6 is a conceptual view of a PV yield system according to the present invention being applied to a SPP;

FIG. 7 is a conceptual view showing how the PV yield system calculates power generation loss; and

FIG. 8 is a conceptual view showing module power attenuation.

### DETAILED DESCRIPTION OF THE PREFERRED EMBODIMENTS

The present invention will now be described with some preferred embodiments thereof and by referring to the accompanying drawings.

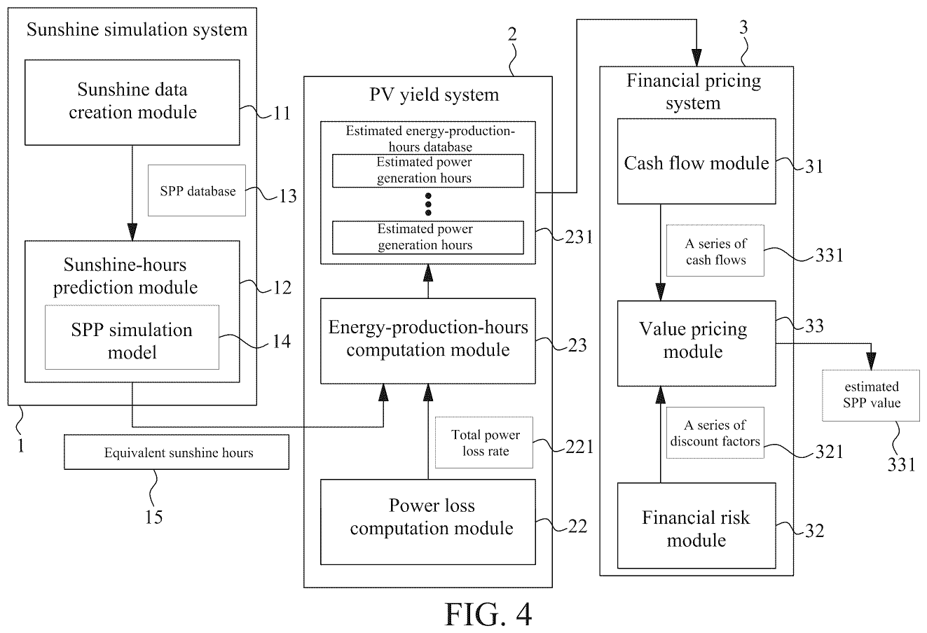

It is to be understood that the term “model” or “module” as used herein includes a meaning that refers to a component that can be implemented as or include software or hardware, or a combination of software and hardware. For example, a sunshine data creation module 11 as shown in FIG. 4, and other modules 12, 14, 22, 23, 31, 32 and 33 can implemented as software and stored in a memory of a computer, such as a first computer 40, a second computer 44 and/or a third computer 45. The models/modules can include instructions (alternatively, “programs,” “code” or “program code”) executable by a processor or processors of the computers to perform the various operations described herein. The models/modules implemented as hardware or a combination of software and hardware can include, for example, firmware and/or one or more ASICs (application specific integrated circuits).

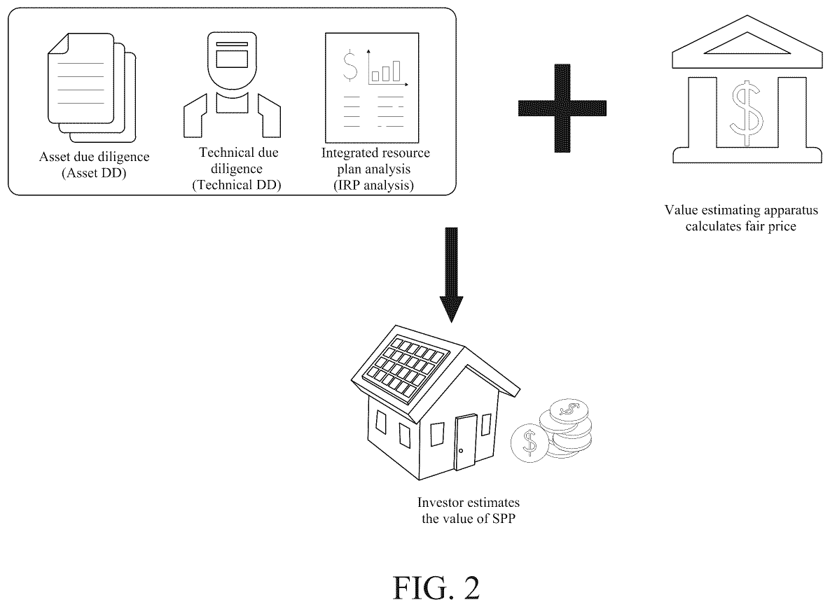

Please refer to FIG. 2. The present invention aims to a value estimating apparatus for analyzing the value of a SPP, which is also briefly referred to as a power station herein. In the value analysis, a financial engineering framework is adopted. This framework not only provides an estimation of values of derivatives financial contracts, such as stock futures, interest rate swaps, stock options, credit default swaps and so on, but also provides an estimation of weather index and catastrophe-related derivative contracts or insurance policies.

Because solar power and weather indexes (such as temperature index, wind speed, rainfall index and so on) are not tradable assets, it is impossible to construct a risk-free investment portfolio with underlying index and derivatives contracts. Nevertheless, there is still a large quantity of academic literature that uses the risk-neutral probability measure (hereafterQ) to value derivatives and insurance policies. Due to no spot market for these underlying assets or indexes, the asset pricing model proposed by Lucas (1978) is adopted and is called the Lucas Equilibrium Pricing Model. A representative trader's utility function is used to calculate the price of risk, that is, the acceptable risk compensation for bearing one unit of risk. Further, under the financial engineering framework adopted in the present invention. The value pricing module computes a series of present values, and the present values are the product of a series of cash flows and a plurality of discount factors. Then, the value pricing module sums up all the present values to obtain an estimated value of an SPP. The value estimating apparatus also introduces a plurality of stochastic factors of interest rates and a plurality of exchange rates into the model. Therefore, the results from the value estimating apparatus of the present invention are close to the real market.

Compared to the conventional value estimating model based on “annually fixed cash flows”, the value estimating apparatus of the present invention provides clients with a more valuable reference of SPP value. Additionally, some risk factors are unable to find in the power generation database can be found through the field DD at the site of the SPP. In summary, the value estimating apparatus of the present invention can reduce the occurrence of such risk factors effectively.

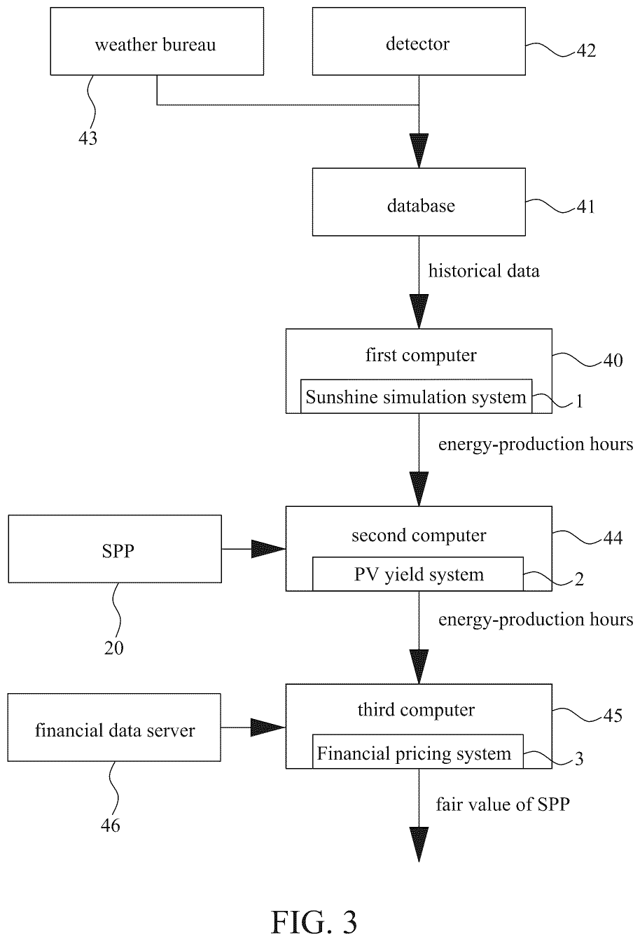

Please refer to FIG. 3. The apparatus for estimating the value of a SPP according to the present invention aims to estimate the value of an existing SPP or a new SPP. As shown, the value estimating apparatus includes a sunshine simulation system 1 for simulating sunshine hours, a photovoltaic (PV) yield system 2 for simulating energy-production hours, and a financial pricing system 3 for estimating a fair value of the SPP.

Please refer to FIG. 4. The sunshine simulation system 1 is installed in a first computer 40 and includes a sunshine data creation module 11 and a sunshine-hours prediction module 12. The sunshine data creation module 11 links to a database 41 through the Internet. In the existing SPP case, the database 41 receives sunshine hours, temperature and humidity from a plurality of detectors 42 assembled at the existing SPP, so that the first computer 40 is configured to get SPP historical data of the existing SPP including sunshine 111 and temperature 112. And the sunshine data creation module 11 creates a SPP database 13 according to the SPP historical data including the sunshine 111 and the temperature 112. In a preferred embodiment, the detector 42 is a Pyranometer and/or a meteorological sensor.

In the new SPP case, the database 41 receives sunshine hours, temperature and humidity from a weather bureau 43, so that the first computer 40 is configured to get SPP historical data of the new SPP including sunshine 111 and temperature 112.

The sunshine-hours prediction module 12 includes a SPP simulation model 14. The SPP database 13 is input to the SPP simulation model 14, so as the SPP simulation model 14 generates equivalent sunshine hours 15 by the first computer 40.

The equivalent sunshine hours 15 have a continuous-time dynamic process. However, the mean or the variance of the sunshine hours performs seasonality. To capture seasonality, the truncated Fourier series is introduced into the dynamic process in the present invention.

The SPP simulation model 14 can perform an algorithm on an existing SPP data corresponding to the existing SPP or a new SPP data corresponding to the new SPP. The existing SPP data includes historical data including sunshine 111 and temperature 112 from the old SPP; and the new SPP data includes historical data including sunshine 111 and temperature 112 from a weather bureau.

In an operable embodiment, the SPP simulation model 14 further introduces the seasonal mean and the seasonal variance of climate factors into the algorithm performed on the SPP database 13.

There are two terms used in calculating solar insolation, namely, Peak Sun-Hours (PSH) and Equivalent Sunshine Hours (ESH). Since PSH is used commonly by the US PV industry as a general term for the calculation of power generation, the term PSH is used in the present invention as the uniform term in calculating solar insolation.

The units commonly used for measuring solar irradiance are MJ/m² and kWh/m², and the irradiance in one day is expressed by Z. Then, the relation among the PSH, MJ/m² and kWh/m² is expressed by the following formula:

$$Z \times \frac{MJ}{{m}^{2}} ( = Z \times \frac{MJ \times h}{{m}^{2} \times h} = Z \times \frac{MJ \times h}{{m}^{2} \times 3600 s} = \frac{Z}{3.6} \times \frac{kWh}{{m}^{2}} ) = \frac{1 kW}{{m}^{2}} \times \frac{Z}{3.6} \times PSH$$

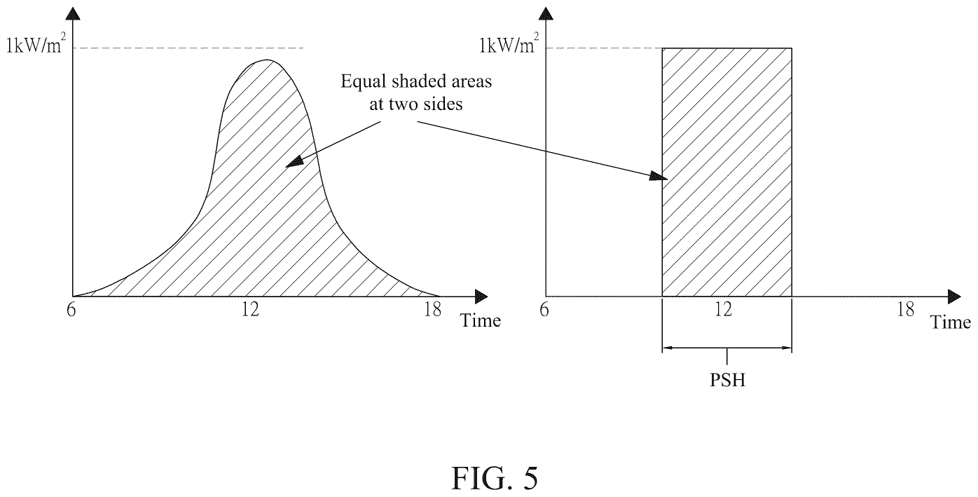

Please refer to FIG. 5. The definition of PSH is the equivalent sunshine hours under Standard Test Condition (STC) of converting the local irradiance to 1000 W/m². That is, the total hours of full power operation for the solar module in one day, which is an important factor for evaluating solar energy production. The larger the numerical value, the stronger the local sunshine, and the more power can be generated. The PSH 15 is a solar module for light to electrical energy conversion without taking any module loss into consideration.

The SPP simulation model 14 considers a filtered probability space {Ω, [symbol] , [symbol] , { [symbol] (t)}ₜ₌₀^{T}} generated by the standard Brownian motion [symbol] (t). The notations are described in order as follows. Ω is a universe set containing all outcomes. [symbol] is a subset sigma-field of Ω; [symbol] is the physical probability measure. { [symbol] (t)}ₜ₌₀^{T} is a series of information sets of the standard Brownian motion containing time points t.

Let the equivalent sunshine hours 15 be X(t). Since the number of hours must be a positive real number, the equivalent sunshine hours 15 used in the present invention is a nature logarithm expressed by ln X(t). The dynamic process of ln X(t) assumes to follow the mean-reverting process with seasonal mean and variance (hereafter MR-SM-SV), as shown below:

$$d ln X ( t ) = ( κ [ ln s ( t ) - ln X ( t ) ] + \frac{d ln s ( t )}{dt} ) dt + \sqrt{v ( t )} {dW}^{ℙ} ( t ) , \qquad ( 16 )$$

The notations are described in order as follows. ln s(t) is the long-term mean level of the ln X(t) affected by climate factors. κ is the mean-reverting force. v(t) is an instantaneous variance. Since the ln X(t) performs a seasonality, a deterministic functions of the v(t) used in the present invention is shown below:

$$v ( t ) = v + {\sum }_{u = 1}^{q} [ {β}_{s , u} sin ( ω ut ) + {β}_{c , u} cos ( ω ut ) ] > 0 , \qquad ( 17 )$$

The notations are described in order as follows.

$$ω = \frac{2 π}{365}$$

is cycle. sin(ωt) and cos(ωt) are seasonal factors. To ensure the variance is always a positive number, the parameters are restricted to v≥Σᵤ₌₁^{q}\sqrt{β_{s,u}²+β_{c,u}²}. Further, since the long-term mean level is a time function, an adjustment term d ln s(t)/dt must be added for the trend of ln X(t). Further, the setting of the variances v(t) is to refer to Huang, Yang, and Change (2018). The empirical results thereof are taken as a reference in the present invention. Based on this fact, the truncated Fourier series is adopted for the variances of ln X(t) in the present invention.

According to Itô lemma, given the information set [symbol] (t), when u(u≥t), the ln X(t) is expressed by the following equation:

$$ln X ( u ) = ln s ( u ) + [ ln X ( t ) - ln s ( t ) ] {e}^{- κ ( u - t )} + {\int }_{t}^{u} {e}^{- κ ( u - η )} \sqrt{v ( η )} {dW}^{ℙ} ( η ) . \qquad ( 18 )$$

The third term of the above equation can be deemed as a sum of a series of random variances following normal distribution. Because the normal distribution is additive, the ln X(u) still follows the normal distribution, and the conditional expectation and the conditional variances thereof can be expressed by the following equations:

$${E}_{𝔽 ( t )}^{ℙ} [ ln X ( u ) ] = ln s ( u ) + [ ln X ( t ) - ln ws ( t ) ] {e}^{- κ ( u - t )} , \qquad ( 19 )$$

$${Var}_{𝔽 ( t )}^{ℙ} [ ln X ( u ) ] = {\int }_{t}^{u} {e}^{- 2 κ ( u - v )} V ( v ) dv = {\#a}_{1} + {\#a}_{2} + {\#a}_{3} , \qquad ( 20 )$$

$$where$$

$$\begin{matrix}{\#a}_{1} = \frac{{β}_{0} ( 1 - {e}^{- 2 κ ( u - t )} )}{2 κ} , \\ {\#a}_{2} = \frac{2 {κβ}_{1}}{{ω}^{2} + 4 {κ}^{2}} [ sin ( ω u ) - sin ( ω t ) {ee}^{- κ ( u - t )} ] - \frac{{ωβ}_{1}}{{ω}^{2} + 4 {κ}^{2}} [ cos ( ω u ) - cos ( ω t ) {e}^{- κ ( u - t )} ] , \\ {\#a}_{3} = \frac{{ωβ}_{2}}{{ω}^{2} + 4 {κ}^{2}} [ sin ( ω u ) - sin ( ω t ) {e}^{- κ ( u - t )} ] - \frac{2 {κβ}_{1}}{{ω}^{2} + 4 {κ}^{2}} [ cos ( ω u ) - cos ( ω t ) {e}^{- κ ( u - t )} ] .\end{matrix} \qquad ( 23 )$$

From the empirical results, the variance of ln X(t) has the characteristic of being smaller in summer and larger in winter; it means ln X(u) has seasonal variance no matter. In the subsequent model description, this feature must be taken into consideration.
The long-term mean level of the equivalent sunshine hours 15 is determined by seasonality factors, and is expressed by the following equations:

$$ln s ( t ) = μ + θ Y ( t ) + {\sum }_{u = 1}^{p} [ {α}_{s , u} sin ( ω ut ) + {α}_{c , u} cos ( ω ut ) ] , \qquad ( 24 )$$

$$Y ( t ) = [ \begin{matrix}{Y}_{1} ( t ) \\ ⋮ \\ {Y}_{N} ( t )\end{matrix} ] , {Y}_{i} ( t ) = {γ}_{i , 0} + {γ}_{i , 1} t + {\sum }_{u = 1}^{q} [ {γ}_{i , s , u} sin ( ω ut ) + {γ}_{i , c , u} cos ( ω ut ) ] , \qquad ( 25 )$$

The notations are described in order as follows.

$$ω = \frac{2 π}{365}$$

is cycle; t is time trend term; and sin(ωt) and cos(ωt) are seasonal factors. Because the climate factors, Y(t) are endogenous, the setting of the above-mentioned model is similar to the two-stage least squares regression model. That is, the first stage to calculate the climate factor in specific periods according to the time trend, and seasonal factors. The second stage is to calculate the long-term mean level.
Please refer back to the Equation (16). The dynamic process of the PSH follows the long-term mean level ln s(t) to go up and down, and the long-term mean level trend of the PSH can be expressed by the Equations (24) and (25). Therefore, in estimating model parameters, the control variables, Y(t) in the long-term mean level must be estimated as the priority. Let parameter set Γᵢ={γ_{i,0}, γ_{i,1}, γ_{i,s,u}, γ_{i,c,u}}, it can be estimated according to the least square method as below.

$${\hat{Γ}}_{i} = arg {min}_{{Γ}_{i}} {\sum }_{t = 1}^{T} {[ {Y}_{i} ( t ) - {γ}_{i , 0} - {γ}_{i , 1} t - {\sum }_{u = 1}^{q} [ {γ}_{i , s , u} sin ( ω ut ) + {γ}_{i , c , u} cos ( ω ut ) ] ]}^{2} \qquad ( 26 )$$

After getting the estimated parameters \acute{Γ}₁, start calculating the expected value of the climate factor using the following equation.

$${\hat{Y}}_{i} ( t ) = {\hat{γ}}_{i , 0} + {\hat{γ}}_{i , 1} t + {\sum }_{u = 1}^{q} [ {\hat{γ}}_{i , s , u} sin ( ω ut ) + {\hat{γ}}_{i , c , u} cos ( ω ut ) ] . \qquad ( 27 )$$

Let parameter set Ψₓ={κ, μ, α_{s,u}, α_{c,u}, ν, β_{s,u}, β_{c,u}, θ}. In the present invention, the dynamic process of ln X(t) in a given period [t−1, t] follows the normal distribution, and its mean and variances can be expressed by the following equations

$${μ}_{X} ( t ; {Ψ}_{X} ) = ln s ( t ) + [ ln X ( t - 1 ) - ln s ( t - 1 ) ] {e}^{- κ} , \qquad ( 28 )$$

$${σ}_{X}^{2} ( t ; {Ψ}_{X} ) = \# {a}_{1} + \# {a}_{2} + \# {a}_{3} , \qquad ( 29 )$$

$$where$$

$$s ( t ) = exp [ μ + θ Y ( t ) + {\sum }_{u = 1}^{q} [ {γ}_{i , s , u} sin ( ω ut ) + {γ}_{i , c , u} cos ( ω ut ) ] ] \qquad ( 30 )$$

$$\# {a}_{1} = \frac{{β}_{0} ( 1 - {e}^{- 2 κ} )}{2 κ} \qquad ( 31 )$$

$$\# {a}_{2} = \frac{2 {κβ}_{1}}{{ω}^{2} + 4 {κ}^{2}} [ sin ( ω t ) - sin [ ω ( t - 1 ) ] {e}^{- 2 κ} ] - \frac{{ωβ}_{1}}{{ω}^{2} + 4 {κ}^{2}} [ cos ( ω t ) - cos [ ω ( t - 1 ) ] {e}^{- 2 κ} ] , \qquad ( 32 )$$

$$\# {a}_{3} = \frac{{ωβ}_{2}}{{ω}^{2} + 4 {κ}^{2}} [ sin ( ω t ) - sin [ ω ( t - 1 ) ] {e}^{- 2 κ} ] + \frac{2 {κβ}_{2}}{{ω}^{2} + 4 {κ}^{2}} [ cos ( ω t ) - cos [ ω ( t - 1 ) ] {e}^{- 2 κ} ] 3 \qquad ( 33 )$$

Parameters of the dynamic process can be estimated according to the maximum likelihood estimation using the following equation:

$${\hat{Ψ}}_{X} = arg {max}_{{Ψ}_{X}} {\sum }_{t = 2}^{T} \{ - \frac{1}{2} ln [ 2 {πσ}_{X}^{2} ( t ; Ψ ) ] - \frac{{[ ln X ( t ) - {μ}_{X} ( t ; Ψ ) ]}^{2}}{2 {σ}_{X}^{2} ( t ; Ψ )} \} . \qquad ( 34 )$$

The sunshine simulation system 1 improves prediction timeliness of sunshine hours through detecting data on-site and computations of the first computer 40. The sunshine simulation system 1 is based on mathematical modeling technology for improving prediction accuracy in different environmental conditions. Further, the sunshine simulation system 1 is also suitable for the existing SPP and the new SPP; and each module of data detection, data transmission, modeling and prediction can operate independently, so that sunshine simulation system 1 is more convenient to use.

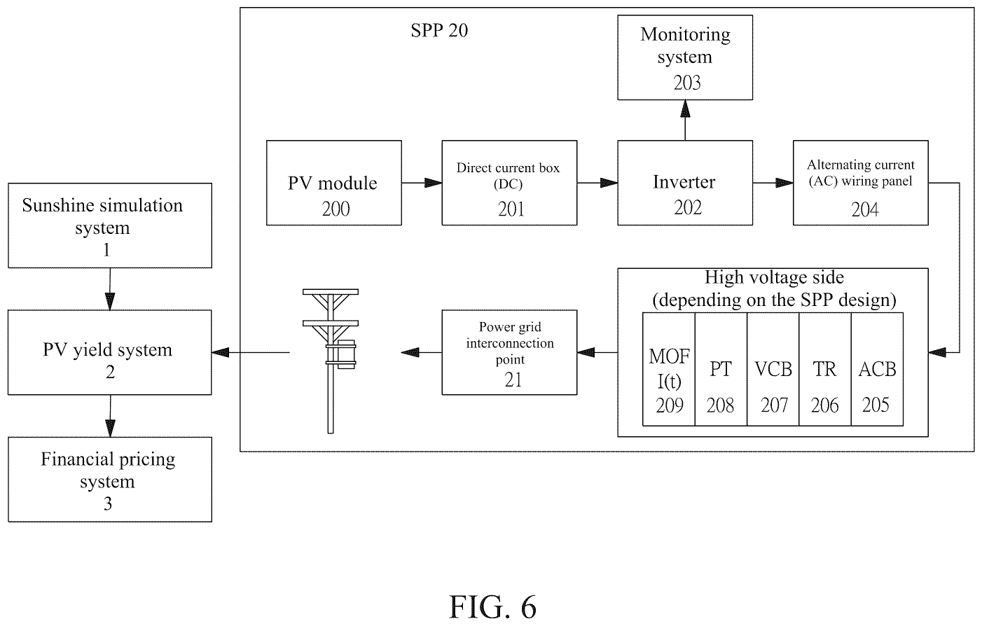

Please refer to FIG. 4. The PV yield system 2 is installed in a second computer 44 and further includes a power loss computation module 22 and an energy-production-hours computation module 23. The power loss computation module 22 links to a SPP 20 for getting data numerical values. Please refer to FIG. 6. The SPP 20 includes at least one PV module 200, a direct current (hereafter DC) box 201, an inverter 202, a monitoring system 203, an alternating current (hereafter AC) wiring panel 204, an air circuit breaker (hereafter ACB) 205, a transformer (hereafter TR) 206, a vacuum circuit breaker (hereafter VCB) 207, a potential transformer (hereafter PT) 208, a metering outfit (hereafter MOF) 209, and a power grid interconnection point 21.

The PV module 200 is configured for converting solar energy to direct current. The DC box 201 is configured for gathering the junctions of series-parallel PV arrays of the PV module 200 therein, and internally includes DC switches, fuses, DC surge protection device (hereafter SPD, etc. The inverter 202 is configured for converting the DC current transmitted from the DC boxes 201 into alternating current (AC). The monitoring system 203 collects data of SPP thermometers, pyrheliometers, inverters and electric meters via a data logger to facilitate monitoring of the operating condition of the whole PV system. The alternating current (AC) wiring panel 204 internally includes protection elements and devices, isolation protection devices, protection relays, synchronous and parallel controls, etc. The air current breaker (ACB) 205 will automatically disconnect the fault circuit to protect the lines and electrical equipment when any fault occurs, such as short circuit, overload and voltage drop. The transformer 206 can boost the 380V AC output from the inverter to 11.4 kV. The vacuum circuit breaker (VCB) 207 is a core part of a medium-to-high voltage power switch; the vacuum in its tube provides excellent insulation, so that the disconnected medium-to-high voltage circuit can have a rapid blowing-out of arc and suppress current to avoid the occurrence of incidents or accidents. The potential transformer (PT) 208 is exclusively used for high voltage control and measurement; its primary voltage depends on the measured or controlled circuit voltage, and its secondary voltage is generally 110V; when using the PT 208, the load end must be grounded and is not allowed to have any short circuit. The metering outfit (MOF) 209 is a type of electricity metering equipment; it could not be used to directly measure the circuit with high voltage and large current before the voltage and the current are reduced through a potential transformer (PT) and a current transformer (CT), respectively.

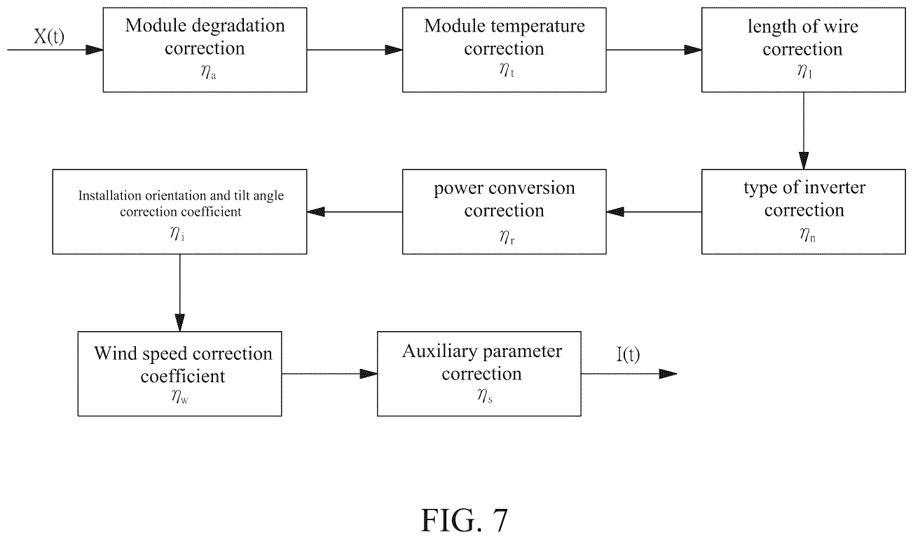

Please refer to FIG. 7. The power loss computation module 22 gets a module attenuation correction no, a module temperature correction ne, a length of wire correction ηₗ, a type of inverter correction ηₙ, and a power conversion correction ηᵣ from the SPP to generate a total power loss rate 221. According to an operable embodiment, the power loss computation module 22 can further get an installation orientation and tilt angle correction coefficient ηₗ a wind speed correction coefficient η_{w}, and an auxiliary parameter correction ηᵢ, to help computation of the total power loss rate 221. The auxiliary parameter correction ηₛ includes a fault loss coefficient, a hot spot loss coefficient, and a connector and socket loss coefficient.

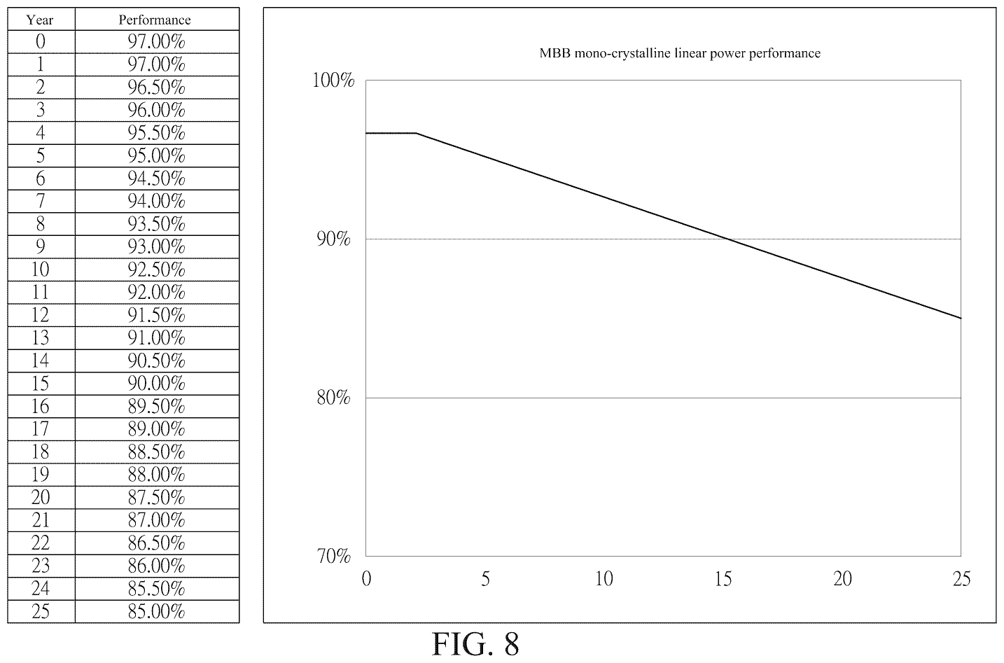

The module attenuation correction ηₐ means the module power, i.e. nominal power, output attenuates every year. Please refer to FIG. 8, in which a Multi-busbar (MBB) Mono-Crystalline Linear Power Performance is shown. In FIG. 8, the percentages of the maintained power generation of the module at different years of use are listed in detail. In brief, the power generation of the module in the first year of use reduces 3%, and it reduces 0.5% each subsequent year of use. Thus, the module still maintains 85% power generation capacity at the 25^{th} year of use.

The module temperature correction ηₜ means the reduction of power when the module temperature is too high. The nominal power indicated by the original manufacturer means the power under the standard test conditions (STC), that is, a solar irradiance of 1000 W/M², a temperature of 25° C., and an air mass of AM1.5. Generally, the nominal power of a module is about (−0.3˜−0.5%) (° C.). That is, the power will reduce each time the temperature increases 1° C. Therefore, keeping the module at a low temperature is beneficial to the power generation.

Generally, a module data sheet lists three coefficients, namely, temperature coefficient α of short-circuit current I_{SC}, temperature coefficient β of open-circuit voltage V_{OC}, and temperature coefficient γ of nominal power P_{N}. Corrected values of the temperature-affected short-circuit current I_{SC}, open-circuit voltage V_{OC} and nominal power P_{N}, respectively, can be calculated using the following equations, wherein T is module temperature.

$$Corrected value of the short - circuit current = {I}_{SC} [ 1 + α ( T - 25 ) ] \qquad ( 35 )$$

$$Corrected value of the open - circuit voltage = {V}_{OC} [ 1 + β ( T - 25 ) ] \qquad ( 36 )$$

$$Corrected value of the nominal power = {P}_{N} [ 1 + γ ( T - 25 ) ] \qquad ( 37 )$$

$$Short - circuit current of PV arrays = {I}_{SC} [ 1 + α ( T - 25 ) ] \times the number of serially connected PV arrays \qquad ( 38 )$$

$$Open - circuit voltage of PV arrays = {V}_{OC} [ 1 + β ( T - 25 ) ] \times the number of parallely connected PV arrays \qquad ( 39 )$$

$$Nominal power of PV arrays = {P}_{N} [ 1 + γ ( T - 25 ) ] \times total number \qquad ( 40 )$$

$$Total number = the number of serial connections \times the number of parrallel connections \qquad ( 41 )$$

Where, α, β, and γ are the temperature coefficients of I_{SC}, V_{OC} and P_{N}, respectively.

Regarding the length of wire correction ηₗ, the mathematic formula of resistance value is as follows:

$$R = ρ \times \frac{l}{A} ( Ω ) \qquad ( 42 )$$

Where, (A) is the cross-sectional area of an object; current flows through the object perpendicular to its cross section, the thicker the object is, the smaller the resistance value is and the easier the electric charges move; (l) is the actual length of the object through which the current flows; the shorter the object is in length, the smaller the resistance value is and the easier the electric charges move; and (ρ) is resistance coefficient indicating the capability of a material of resisting electric charges from flowing therethrough; the material with better conductivity has a smaller resistance coefficient; and the unit is W·m.

The relation between resistance and temperature is:

$$\frac{{R}_{1}}{{R}_{2}} = \frac{\vert {T}_{0} \vert + {T}_{1}}{\vert {T}_{0} \vert + {T}_{2}} ( Taking soft copper as an example ) \qquad ( 43 )$$

Where, T₀ is zero resistance temperature, which depends on the material of a conductor (for example, the zero resistance temperature of soft copper material is −234.5° C.); T₁ is the temperature corresponding to R₁; and T₂ is the temperature corresponding to R₂.

Regarding the type of inverter correction ηₙ, it is explained below. An inverter can convert the DC power supplied by solar cells into AC power. In the case of supplying the power to the connected AC system loads, any surplus power can also be delivered back to the power system. Or alternatively, the generated power is not provided to loads but is completely sold in wholesale. Therefore, the inverter is prerequisite for connecting the power grid to the PV system. Since the grid-tie inverter is power electronic element featured by low switching loss, low on resistance, and low current leakage, the inverter is usually designed to have an input of high voltage specification and have high AC to DC conversion efficiency, so that the originally not high conversion efficiency of PV modules won't be further reduced due to the low conversion efficiency of the inverter to reversely affect the conversion efficiency of the entire solar power generation system.

Regarding the power conversion correction ηᵣ, it is explained below. Once the PV system connects to a high-voltage power grid or an extra high-voltage power grid, the SPP must have distribution-owned substations for boosting the AC power output of inverters, which is generally 380V, to a voltage value the same as the power grid, such as 11.4 kV, 22.8 kV or even higher voltage, before the PV system can be connected with the power grid. To do this, transformers are relied on. With such a high boost ratio, the loss normally could not be ignored. Generally, the monitoring system is mainly connected to inverters to reflect performance ratio (PR) for the PV system. The PV system, unless it is a small-scaled SPP, can be directly connected with a 220V/380V power grid without the need of transformers.

Regarding the installation orientation and tile angle correction coefficient ηᵢ, it means that, when there is a deviation in the PV module installation orientation, the power generation of the PV module will decrease. The orientation of the PV module means an included angle between a vertical surface of the PV module and the south direction. The orientation is negative if the PV module is oriented more to the East, and is positive if the PV module is oriented more to the west. In general conditions, when the PV module is orientated to the south (i.e. the included angle between the vertical surface of the PV module and the south is 0°), the solar cells have the maximum power generation; when the orientation of the PV module deviates from the south by 30° (in the case of the northern hemisphere), the power generation of the PV module will decrease about 10% to 15%; and when the orientation of the PV module deviates from the south by 60° (in the case of the northern hemisphere), the power generation will decrease about 20% to 30%.

However, in the sunny days of summer, the maximum solar irradiance appears shortly after noon. Therefore, the PV module oriented a little more to the west would have the maximum power generation after noon. In different seasons, the PV module can be oriented a little more to the east or the west to get the maximum power generation.

Further, the tilt angle of the PV module means an included angle between the surface of the module and the level ground. It is expected this included angle is the optimal tilt angle of the PV module at which the PV module can have the maximum power generation in one year. The optimal tilt angle in each year is related to the latitude of the location at where the PV module is installed. When the PV module is installed in a higher latitude area, the tilt angle of the PV module is increased correspondingly. However, like the orientation, some limits must be taken into consideration in designing the PV module tilt angle, such as the roof tilt angle and the roof snow sliding-off tilt angle (that has a slope larger than 50% to 60%). For a PV module oriented to the south (i.e. the orientation is) 0°, when the tilt angle starts gradual transition from the level (i.e. the tilt angle is) 0° to an optimal tilt angle, the solar irradiance increases constantly until it reaches the maximum value. And then, the tilt angle keeps increasing and the solar irradiance decreases constantly. Particularly, after the tilt angle is larger than 50° to 60°, the solar irradiance reduces drastically. When the PV module reaches its final position, i.e. being positioned vertically, the power generation is decreased to the minimum quantity. There are practical examples of different PV module positions, from vertical position to inclined position at a tilt angle of 10° to 20°. In the case the orientation is not zero, the solar irradiance value on a tilted surface is generally relatively lower and the maximum solar irradiance value appears when the tilt angle is close to the level.

The wind speed correction coefficient η_{w} means that increased wind speed can reduce module temperature. When the photovoltaic (PV) module 200 is installed on an area with a relatively higher wind speed or having good ventilation, the heat loss can be effectively reduced. In the association rules analysis, a linear negative correlation is found between wind speed and module temperature. However, the module temperature reduction is uneasy to perceive, unless the wind speed is higher than 8 m/s.

The fault loss coefficient means that when the module is influenced by shade to have decreased solar cell power generation, the bypass diodes in the junction box behind the module will be activated for the power generation lines to bypass the affected solar cell zones to thereby avoid causing even larger power generation loss. In the junction box, there are three bypass diodes, each of which is parallelly connected to 20 solar cells to control one-third (⅓) of module's power generation. Therefore, one short-circuit and fault bypass diode would directly cause a loss of ⅓ power generation of the module to severely affect the SPP.

The hot spot loss coefficient means the forming of hot spots on the PV module owing to different causes, such as collision in transportation, stepping on or washing the PV module, bird's dropping, accumulated sands and shade, will also cause relatively significant power generation loss. The hot spots are captured using a thermographic camera drone to enable good control of the power generation loss.

The connector and socket loss coefficient means that, in the connection of the source of the PV module to the point of common coupling (PCC) of the power company to interconnect with the power grid, since a lot of MC4 connectors, terminal holders and fuse holders are included in the wiring, any poor contact thereof would lead to an excessively high resistance, which would also cause power generation loss. Maybe the power generation loss at a single point does not catch much attention, but the total power generation loss at a large number of points would be highly significant.

According to the description of different losses, the following calculation formulas are adopted in the PV yield system 2:

$${P}_{AC} = {P}_{N} \frac{{E}_{q}}{{W}_{s}} {η}_{a} {η}_{t} {η}_{i} {η}_{w} {η}_{l} {η}_{n} {η}_{r} {η}_{s} \qquad ( 44 )$$

$$I ( t ) = X ( t ) {η}_{a} {η}_{t} {η}_{i} {η}_{w} {η}_{l} {η}_{n} {η}_{r} {η}_{s} \qquad ( 45 )$$

### Where,

I(t) is the total power generation of the SPP;
X(t) is the total equivalent sunshine hours of the SPP;
P_{AC} is the transformer's AC output power→I(t);
P_{N} is the installed capacity;
E_{q} is the solar irradiance→X(t);
Eₛ is the standard solar irradiance (1000 W/m²);
ηₐ is the module attenuation correction;
ηₜ is the module temperature correction=[1+(Tₘ−25)×γ], wherein Tₘ is module temperature;
ηᵢ is the module orientation and tilt angle correction coefficient;
η_{w} is wind speed correction (this is the only coefficient that is larger than 1);
ηₗ is the length of wire correction (this is calculated by adding cable length to temperature correction);
ηₙ is type of inverter correction (this is a fixed correction coefficient, for example, 95%, which does not change with time);
ηᵣ is the power conversion correction (this is a fixed correction coefficient, for example, 95%, which does not change with time); and
ηₛ is auxiliary parameter correction by module hot spots, bypass diode fault, and poor contact at the MC connectors, terminal holders and fuse holders.

The energy-production-hours computation module 23 divides an estimating period into multiple time segments according to a time interval, and uses the time segments along with the equivalent sunshine hours 15 and the total power loss rate 221 to generate an estimated energy-production-hours database 231, which contains a plurality of estimated energy-production-hours at different time segments.

Given the power generation hour I(t), it is expressed by the following equation:

$$I ( t ) = {P}_{N} \cdot \frac{X ( t )}{{E}_{S}} \cdot {η}_{α} ( t ) \cdot \{ 1 + [ {T}_{m} ( t ) - 25 ] \cdot γ \} \cdot {η}_{i} \cdot {η}_{w} \cdot {η}_{ℓ} \cdot {η}_{n} \cdot {η}_{r} \cdot {η}_{s} \qquad ( 46 )$$

The notations are described in order as follows. P_{N} is the SPP installed capacity; E_{S} is the standard solar irradiance (kW/m²); ηₐ(t) is the module attenuation correction; 1+[Tₘ(t)−25]·γ is module temperature correction; ηᵢ is the module orientation and tilt angle correction coefficient; η_{w} is the wind speed correction; ηₗ is the line loss correction; ηₙ is the inverter conversion loss correction; and ηᵣ is the transformer boosting loss correction. Let variable Y(Tᵤ,Tᵤ₊₁) be the total power generation in the period [Tᵤ, Tᵤ₊₁], and set Tᵤ₊₁−Tᵤ to be 2 months, then the following equation is obtained:

$$Y ( {T}_{u} , {T}_{u + 1} ) = {\sum }_{u = {T}_{u}}^{{T}_{u + 1}} I ( t ) . \qquad ( 47 )$$

Please refer to FIG. 4 again. The financial pricing system 3 is installed in a third computer 45 and gets necessary financial data in the Internet. The financial pricing system 3 includes a cash flow module 31, a financial risk module 32, and a value pricing module 33. The cash flow module 31 generates a series of cash flows 311 from the estimated energy-production-hours database 231 multiplying a pre-determined purchase price. The cash flow module 31 links to the first computer 40 to get the estimated energy-production-hours database 231. The third computer 45 can link to an electric power company to get a latest purchase price for being the pre-determined purchase price, or directly input the pre-determined purchase price by a user to the third computer 45.

The financial risk module 32 links to a financial data server 46 to get financial historical data including a plurality of domestic and foreign Treasury yield curves, a plurality of exchange rates and a plurality of interest rates. The financial risk module 32 creates a risk simulation model based on the exchange rates and the interest rates; the risk simulation model creates a plurality of parameters of the financial risk model from the domestic and foreign Treasury yield curves and the exchange rates. Then, the financial risk module 32 generates a series of discount factors with a plurality of simulated interest rates and a plurality of simulated exchange rates. In a preferred embodiment, the financial data server 46 is a bank server or a stock exchange server. The value pricing module 33 computes a series of present values 331 of the cash flows 311 by the third computer 44, and the present values 331 are the product of the cash flows 311 and the discount factors 321. Then, the value pricing module 33 sums up all the present values 331 to obtain an estimated value of an SPP.

The financial risk module 32 can acquire dynamic processes of spot interest rate and spot exchange rate. The processes of the domestic and foreign spot interest rates follow Diebold and Li (2006), as expressed by the following equation.

$${R}_{k} ( 0 , t ) = {β}_{1 , k} ( 0 ) + {β}_{2 , k} ( 0 ) \frac{1 - {e}^{- λ t}}{λ t} + {β}_{3 , k} ( 0 ) ( \frac{1 - {e}^{- λ t}}{λ t} - {e}^{- λ t} ) . \qquad ( 48 )$$

The notations are described in order as follows. k is the code for domestic (D) and foreign (F); β_{1,k}(0) is the intensity of level for the yield curve; β_{2,k}(0) is the intensity of slope for the yield curve; β_{3,k}(0) is the intensity of curvature for the yield curve; A is the year-to-maturity corresponding to peak of yield curve.

These three intensities follow the vector autoregressive (hereafter VAR) model and are expressed as follows

$${β}_{k} ( t ) = {α}_{1 , k} + {α}_{2 , k} \cdot {β}_{k} ( t - 1 ) + {ε}_{k} ( t ) , \qquad ( 49 )$$

$${ε}_{k} ( t ) {\sim}^{IID} MV Normal ( {0}_{3 \times 1} , {\sum }_{k} ) \qquad ( 50 )$$

The notations are described in order as follows. βₖ(t) is the vector of three intensities; α_{1,k} is the vector of intercept terms and is be seen as the intensity of long-run mean level; α_{2,k} is the diagonal matrix corresponding to the first-order coefficients of autoregression; εₖ(t) is the vector of residuals following the multi-variables normal distribution; 0_{3×1} is the vector of zero; Σₖ is the diagonal matrix corresponding to standard deviations of residuals.

The USD to TWD spot exchange rate is expressed by G(t), its dynamic process follows the autoregressive (hereafter AR) model and is expressed as follows.

$$ln G ( t ) = {α}_{1 , G} + {α}_{2 , G} \cdot ln G ( t - 1 ) + {ε}_{G} ( t ) , {ε}_{G} ( t ) {\sim}^{IID} Normal ( 0 , {δ}_{G}^{2} ) , \qquad ( 51 )$$

The notations are described in order as follows. α_{1,X} is the intercept term and is seen as the intensity of long-run-mean level; α_{2,G} is the first-order coefficient of autoregression; ε_{G}(t) is the vector of residuals following the normal distribution with the mean 0 and the variance δ_{G}².

The financial risk model generates the SPP's value V_{D}(0) in New Taiwan dollars can be defined as below:

$$\begin{matrix}{V}_{D} ( 0 ) = {\sum }_{u = 0}^{M} {E}^{ℚ} [ {e}^{- {\int }_{0}^{{T}_{u + 1}} {r}_{D} ( s ) ds} \cdot Y ( {T}_{u} , {T}_{u + 1} ) \cdot \overline{p} ] \\ \approx {\sum }_{u = 0}^{M} {E}^{ℚ} [ {e}^{- {\sum }_{s = 1}^{{T}_{u + 1}} {r}_{D} ( s ) Δ} \cdot Y ( {T}_{u} , {T}_{u + 1} ) \cdot \overline{p} ]\end{matrix} \qquad ( 52 )$$

The notations are described in order as follows. p̅ is the wholesale purchase price paid by the Power company for purchasing the solar power generation equipment and solar energy of the SPP; M is the number of times for settling the payment for electricity within the term of a contract. On the other hand, the SPP value V_{F}(0) in US dollars can be defined as below:

$$\begin{matrix}{V}_{F} ( 0 ) = {\sum }_{u = 0}^{M} {E}^{ℚ} [ {e}^{- {\int }_{0}^{{T}_{u + 1}} {r}_{F} ( s ) ds} \cdot G ( u + 1 ) \cdot Y ( {T}_{u} , {T}_{u + 1} ) \cdot \overline{p} ] \\ \approx {\sum }_{u = 0}^{M} {E}^{ℚ} [ {e}^{- {\sum }_{s = 1}^{{T}_{u + 1}} {r}_{F} ( s ) Δ} \cdot G ( {T}_{u + 1} ) \cdot Y ( {T}_{u} , {T}_{u + 1} ) \cdot \overline{p} ]\end{matrix} \qquad ( 53 )$$

Compare formulas (52) and (53). In formula (52), since the SPP's value is priced in New Taiwan dollars, it can be calculated by deriving the present discounted values of the payments to be settled at different time points according to the spot domestic interest rate and then summing all the derived present discounted values of the future payments. In formula (53), since the SPP's value is priced in US dollars, the payments to be settled at different time points in New Taiwan dollars must first be respectively exchanged for US dollars according to the spot exchange rate at each time point of payment, and then sum the present discounted values of the payments derived according to the foreign interest rate to get the SPP's value in US dollars.

It is difficult to derive a closed pricing formula from formulas (52) and (53). Since the present invention takes PSH and stochastic interest rates into consideration, all the existing pricing methods, such as the binomial tree, trinomial tree and finite difference method, could not be used to process a multi-dimensional pricing algorithm easily. Therefore, the present invention adopts the Monte-Carlo pricing method, which has the advantages of being able to use with the dynamic process of any kind of underlying asset, applying simple and intuitive calculation, and providing relatively better computational efficiency under a multi-factor model.

What is claimed is:

1. An apparatus for estimating a value of a solar power plant (SPP), comprising at least one computer configured to implement a sunshine simulation system, a photovoltaic (PV) yield system, and a financial pricing system;
wherein the sunshine simulation system is installed in the least one computer and includes:
a sunshine data creation module for linking to a database through an Internet and getting historical data including sunshine and temperature of the SPP from the database, and creating an SPP database including the historical data; and
a sunshine-hours prediction module including an SPP simulation model; the SPP database being input to the SPP simulation model to generate peak sun hours (PSH);
wherein the PV yield system is installed in the least one computer and includes:
a power loss computation module for getting a total power loss rate including a module attenuation correction, a module temperature correction, a length of wire correction, a type of inverter correction, and a power conversion correction from the SPP; and
an energy-production-hours computation module generating an estimated energy-production-hours database from the PSH and the total power loss rate; and
wherein the financial pricing system is installed in the least one computer and includes:
a cash flow module getting the estimated energy-production-hours database from the energy-production-hours computation module and generating a series of cash flows from the estimated energy-production-hours database by multiplying a pre-determined purchase price;
a financial risk module linking to a financial data server and getting financial historical data including a plurality of domestic and foreign Treasury yield curves, a plurality of exchange rates, and a plurality of interest rates; the financial risk module creating a risk simulation model based on the exchange rates and the interest rates; the risk simulation model creating a plurality of parameters of a financial risk from the domestic and foreign Treasury yield curves and the exchange rates; the financial risk model generating a series of discount factors with a plurality of simulated interest rates and a plurality of simulated exchange rates; and
a value pricing module for computing a series of present values of the cash flows, the present values being a product of the cash flows and the discount factors, and the value pricing module summing up all the present values to obtain an estimated value of the SPP; and
wherein the apparatus supplies the estimated value of the SPP to a party in a trade involving the SPP.

2. The apparatus for estimating the value of a SPP as claimed in claim 1, wherein the SPP simulation model is created according to either data of an old SPP or data of a new SPP; the data of the old SPP including historical data including sunshine hours and temperature of the old SPP; and the data of the new SPP including historical data including sunshine hour and temperature from a weather bureau.

3. The apparatus for estimating the value of a SPP as claimed in claim 2, wherein the PV yield system further includes a module data creation module for getting module temperature data, power generation data and wind speed data in the old SPP.

4. The apparatus for estimating the value of a SPP as claimed in claim 1, wherein the sunshine data creation module organizes different SPP data in a unified format.

5. The apparatus for estimating the value of a SPP as claimed in claim 1, wherein the SPP simulation model further introduces a seasonal mean and a seasonal variance of climate factors into an algorithm.

6. The apparatus for estimating the value of a SPP as claimed in claim 1, wherein the energy loss computation module further gets an installation orientation and tilt angle correction coefficient and a wind speed correction coefficient to help computation of the total power loss rate.

7. The apparatus for estimating the value of a SPP as claimed in claim 1, wherein the power loss computation module further gets an auxiliary parameter correction to help computation of the total power loss rate; and the auxiliary parameter correction includes a fault loss coefficient, a hot spot loss coefficient, and a connector and socket loss coefficient.
